(19) United States
(12) Patent Application Publication
(10) Pub. No.: US 2012/0101886 A1
(43) Pub. Date: Apr. 26, 2012

(54) DYNAMICALLY GENERATED TARGETED SUBSCRIPTION PACKAGE

(76) Inventors: Peruvemba V. Subramanian, Santa Clara, CA (US); Zhiqiang Michael Zhang, San Ramon, CA (US); Lex Bayer, Menlo Park, CA (US)

(21) Appl. No.: 13/278,043

(22) Filed: Oct. 20, 2011

Related U.S. Application Data
(60) Provisional application No. 61/455,324, filed on Oct. 20, 2010.

(51) Int. Cl. G06Q 30/02; G06Q 30/06

(52) U.S. Cl. 705/14.23; 705/26.4

(57) ABSTRACT

Techniques are provided for dynamically generating a customized subscription package to a user of one or more virtual environments. A computer apparatus analyzes one or more user attributes of a user of one or more virtual environments. The computer apparatus determines a customized subscription package for the user. The customized subscription package comprises one or more virtual assets associated with the one or more virtual environments. The customized subscription package is offered to the user.

### CROSS-REFERENCES TO RELATED APPLICATIONS

The present application is a non-provisional application of and claims priority to U.S. Provisional Application No. 61/455,324, filed Oct. 20, 2010, the entire contents of which are herein incorporated by reference for all purposes.

### BACKGROUND

Virtual economies existing in virtual environments such as online games, virtual worlds, and social networks allow virtual items to be purchased from the provider of the virtual environment. Virtual items can also be exchanged between users of the virtual environment. Some virtual environments have a virtual currency that may be used to purchase virtual items for use within the virtual environment. Users may be able to participate in virtual environments at no cost, or the provider of the virtual environment may provide access to the virtual environment on a paid subscription basis.

Virtual goods are unique in that the costs associated with manufacture, inventory and sending an item to a consumer are very low or nonexistent compared with such costs for non-virtual goods. Because the cost of producing and delivering virtual goods is low, a more fluid pricing model is available for virtual goods than is possible for non-virtual goods. The cost of bundling together various physical products and shipping the bundled products to a consumer would be complex to calculate. Each physical product may have a unique weight and shape that may affect the costs and other logistical issues associated with packaging and shipping a bundle of products. These concerns are not applicable to virtual products. However, virtual environments often have subscription models and virtual item pricing that are static. Thus, there remains a need for a system that allows customization of subscriptions and user configurable bundling of virtual goods. Further, there is a need for a system capable of implementing the price optimization that can be achieved due to the unique nature of virtual goods.

An online game is a game, such as a video game, that may be accessed via a network such as the Internet. In some embodiments, the game is a massively multiplayer online game that provides a game interface to a user device via a network. The video game may have an offline component. For example, subscription package offers and access authorization services may be provided via a network and the game interface may be provided to the user partially or entirely without network access.

Embodiments of the invention address these and other problems, individually and collectively.

### BRIEF SUMMARY

Embodiments of the present invention are directed to methods and systems associated with dynamically generating a customized subscription package to offer to a user of one or more virtual environments.

One embodiment of the invention is directed to a method for generating a customized subscription package. The method comprises analyzing, by a computer apparatus, one or more user attributes of a user of one or more virtual environments. The computer apparatus determines a customized subscription package for the user. The customized subscription package comprises one or more virtual assets associated with the one or more virtual environments. The customized subscription package is offered to the user.

Another embodiment of the invention can be directed to a server computer comprising a processor and a computer readable medium coupled to the processor. The computer readable medium can comprise code executable by a processor for implementing the above-described method.

Another embodiment of the invention is directed to a method for comparing acceptance rates of a first subscription package offer and a second subscription package offer. A computer apparatus determines a first customized subscription package that comprises a plurality of virtual assets usable in one or more virtual environments. The computer apparatus also determines a second customized subscription package that comprises a plurality of virtual assets usable in one or more virtual environments. The first customized subscription package is offered to a first subset of users and the second customized subscription package is offered to a second subset of users. The acceptance rate of the first customized subscription package is compared to the acceptance rate of the second customized subscription package.

### BRIEF DESCRIPTION OF THE DRAWINGS

FIG. 1 is a block diagram illustrating a system for presenting a customized subscription package offer for a virtual environment, according to an embodiment of the invention.

FIG. 2 is an illustrative customized subscription package offer, according to an embodiment of the invention.

FIG. 3 is a flow diagram showing illustrative operations involved in generating a subscription package offer, according to an embodiment of the invention.

FIG. 4 is an illustrative user interface for receiving a user input price and generating a customized subscription package offer based on the received price, according to an embodiment of the invention.

FIG. 5 is a flow diagram showing illustrative operations involved in generating a subscription package offer based on a user input price, according to an embodiment of the invention

FIG. 6 is a flow diagram showing illustrative operations involved in optimizing the price of a subscription package, according to an embodiment of the invention.

FIG. 7 is a flow diagram showing illustrative operations involved in customizing subscription package offerings for user subgroups, according to an embodiment of the invention.

FIG. 8 is a flow diagram showing illustrative operations involved in comparing acceptance rates of a first and second subscription package offering, according to an embodiment of the invention.

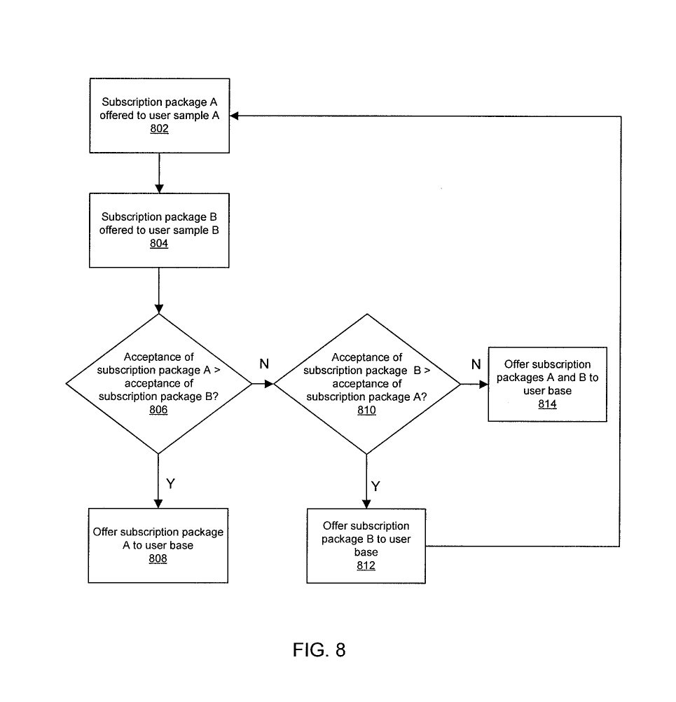

FIGS. 9A-9B are exemplary subscription package offers, according to an embodiment of the invention.

FIG. 10 is a block diagram of a computer apparatus that may be used to implement the payment processing and alerting techniques disclosed herein, according to an embodiment of the invention.

### DETAILED DESCRIPTION

Embodiments of the present invention are directed to systems and methods for dynamically generating and pricing subscription packages for virtual environments. Information associated with a user of a virtual environment is used to build a subscription package customized for a particular user.

A subscription package may refer to a product that may include access to one or more virtual environments and one or more virtual assets, preferably for use in virtual environments. Subscription packages according to an embodiment of the invention can be active for any suitable period of time, and may include any suitable combination of virtual assets (e.g., virtual goods and virtual currency). For example, an exemplary subscription package may comprise only virtual assets such as a package including a predetermined amount of virtual currency (e.g., 50 gold coins), an mp3 of music associated with a particular video game, and a predetermined number of virtual goods (e.g., two weapons, an item of armor, and progress indicators such as points, which can also be used as virtual currency in some cases). A suitable subscription package may also include any suitable pricing scheme. For example, payment for a subscription package may be made periodically (e.g., once a month or once a year) using electronic or real money, or could be paid for using points or credits during game play.

A virtual environment may refer to a computer simulation in which a user can participate, such as a game application, community application, or simulated environment application.

A virtual asset may refer to a unit or plurality of units of virtual currency, or a virtual good. Virtual assets may typically have value of some sort, either in the real world and/or in a gaming environment.

Virtual currency may refer a medium of exchange usable in a virtual environment. Virtual currency may include any suitable digital currency in any suitable form. Examples of virtual currency may include points, electronic coins (e.g., game currency such as gold coins or gold, peer-to-peer digital currency such as Bitcoin, etc.) and electronic dollars. Many virtual currencies cannot be used outside of a particular gaming environment, although other virtual currencies may be usable outside of a particular gaming environment.

Virtual good may refer to anything acquirable for use in a virtual environment. Virtual goods may be items which can represent real world, physical, objects (e.g., a sword or a crown), may include purely digital real world goods (e.g., media such a song, a music album, or a video), and/or represent non-real world objects (e.g., a spell).

Virtual goods that are present or used in gaming environments are different than other types of virtual goods such as music and movies. This is because typically virtual goods in gaming environments are primarily valued within a particular virtual environment, whereas media such as music and movies are universally consumed without regard to a particular virtual environment. As a result, music and movies are often more susceptible to pricing constraints that reach beyond any particular virtual environment, whereas the pricing of virtual goods for the virtual environment may be more fluid.

The term “user” may refer to a person engaged in the use of one or more virtual environments, a person to whom a virtual environment is being advertised, or a person who has expressed an interest in engaging in a virtual environment. A user may express an interest in engaging in a virtual environment, for example, by accessing a virtual environment, visiting a website or other portal associated with the virtual environment, or examining virtual goods associated with the virtual environment. When the virtual environment system detects that a user has expressed an interest in or may be interested in making a purchase, the user is presented with an offer of a subscription package. The subscription package may include one or more of access to the virtual environment, virtual currency usable in the virtual environment and virtual goods usable in the virtual environment. In some embodiments, the subscription package may involve access, virtual currency or virtual goods associated with a plurality of virtual environments. Access to the virtual environment may be provided for a fixed period of time, such as a day, a week, a month, or a year. Access may be automatically or manually renewable on a periodic basis.

User attributes such as the user's past purchase history, demographic information, frequency of access to the virtual environment, virtual assets for use in a virtual environment possessed by the user, and game data related to the user's participation in an online game may be used in generating the subscription package. For example, a subscription package generated for a user may include virtual goods that are appropriate for the level achieved by the user in a game. In another example, if a user has never purchased a virtual good, the virtual good may be presented to the user at a discount. User attributes may be provided by the user to a server associated with the virtual environment via a user interface. A virtual environment associated with a social network may obtain user attributes from a database associated with the social network or another such database that stores user data.

In some embodiments, users may be able to access a virtual environment without subscribing to the virtual environment and receive additional benefits for subscribing to the virtual environment. The user may be offered a subscription package comprising a subscription offer if the user is not a current subscriber to the virtual environment. For existing subscribers, a discounted subscription price may be presented to the user as part of the subscription package.

A user may be able to participate in the customization of a subscription package in accordance with some embodiments. For example, after a subscription package is offered to a user, the user may enabled to add a component to or subtract a component from the subscription package. In another embodiment, the user may be able to switch one or more components of the subscription package for alternative components. Components of the subscription package may include the access term, virtual goods, and virtual currency. The price of the subscription package may be adjusted to reflect the changes made by the user. In a further embodiment, rather than using a subscription package generated by the virtual environment system, the user is able to design a customized subscription package. Alternatively, a user may select a price and a customized subscirpiton package may be generated based on the selected price.

Information about acceptance of subscription package offers by users may be used to optimize the price of the subscription package. This information may also be used to optimize the price of one or more components of a subscription package. Additionally, acceptance rates for subscription packages having different components may be compared to determine which subscription packages are most appealing to users. Further acceptance rates of a particular subscription package by different subsets of users may be compared to target the subscription package to the users most likely to accept it.

Subscription Package Generation

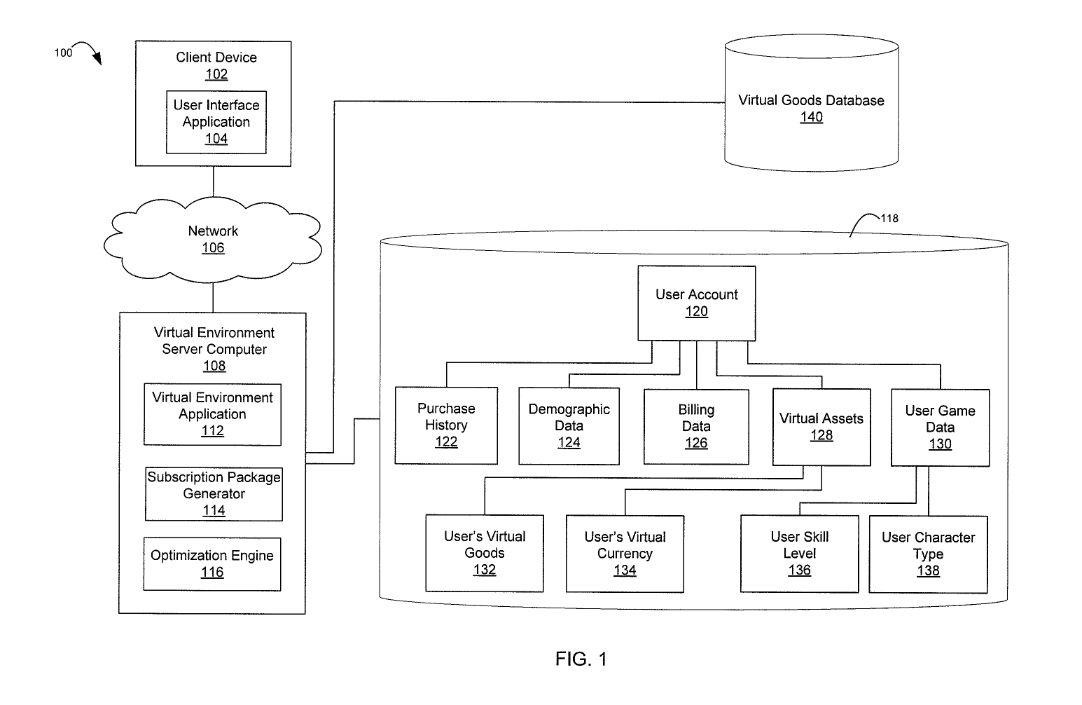

Referring to FIG. 1, a functional block diagram illustrating the primary function elements of an exemplary system for presenting a customized subscription package offer for a virtual environment is shown. Virtual environment system 100 comprises one or more server computers, data processing subsystems and networks that can be used to present a subscription package offer to a user. It is to be understood that embodiments of the invention may include more than one of the components shown individually in FIG. 1. Additionally, some embodiments of the invention may include fewer than all the components shown in FIG. 1.

The term “computer” as used herein refers to a system comprising a processor and a computer readable medium, such as computer memory or other data storage device, coupled to the processor. The computer readable medium stores code executable by the processor. The term “server computer” as used herein indicates a computer or cluster of computers. For example, the server computer can be a mainframe, a minicomputer cluster, or a group of servers functioning as a unit. In one example, a server computer may be a database server coupled to a Web sever. Data transfer and other communications between components such as computers may occur via any suitable wired or wireless network, such as the Internet or private networks.

Virtual system 100 includes one or more virtual environment server computers 108, each of which may run applications associated with one or more virtual environments. The user accesses the virtual environment using client device 102. Client device 102 interfaces with virtual environment server computer 108 via network 106. A user interface application 104 associated with the virtual environment may be an application executed by a processor of client device 102. Client device 102 can be a computing device accessed by the user, for example, a personal computer or mobile computing device. It will be understood that the user interface application associated with the virtual environment may alternatively be an application executed by a processor of virtual environment server computer 108 and accessed by client device 102 via network 106. User interface application 104 is configured to display information to a user, such as a subscription package offer associated with virtual environment application 112, and to receive user input, such as a selection indicating acceptance of a subscription package offer. The user interface application may be an application associated with one or more virtual environments. Alternatively, the user interface application may be a web browser, e-mail interface, SMS client, or other interface capable of displaying a subscription package offer to a user.

One or more virtual environment applications 112 may be executed by a processor of virtual environment server computer 108. The virtual environment can be a computer simulation in which a user can participate. Virtual goods and virtual currency may be usable in the virtual environment. In some embodiments, the virtual environment is a game application.

Subscription package generator 114 of virtual server 108 is configured to assemble a subscription package to offer to a user. The subscription package generator 114 may retrieve one or more user attributes from virtual environment user database 118 for use in customizing a subscription package for the user. Subscription package generator 114 may also query virtual goods database 140 for customization a subscription package. The subscription package generator 114 may further be capable of calculating a price for a subscription package. If the subscription package is modified by a user, the subscription package generator may generate an updated price for the subscription package.

Virtual server computer 108 may further include optimization engine 116. Optimization engine 116 analyzes information regarding acceptance of subscription package offers, such as acceptance rates, and may adjust the pricing of the subscription package offer, the value of components of the subscription package offer, and the quantity of components of subscription package offer. In this manner, subscription package offers can be made more appealing to the overall user base or to target groups within the user base in order to increase the likelihood of acceptance of subscription package offers by users. The term “user base” may refer to all users of a particular virtual environment, or all users of a plurality of virtual environments, or all potential users of a particular virtual environment or a plurality of virtual environments.

When a user has accepted the offer of a subscription package, virtual environment server computer 108 obtains the user's billing information, and, if the transaction is processed successfully, associates the components of a subscription package with a user account. The virtual environment server computer 108 may obtain the user's billing information from user billing data 126 associated with a user account 120 from virtual environment user database 118.

Virtual environment server computer 108 is communicatively coupled to one or more virtual environment user databases 118. In some embodiments, virtual environment user database 118 is stored in the memory of virtual environment server computer 108. The virtual environment user database 118 stores a unique identification for a user account 120 associated with a user. User account 120 may indicate the user's participation in one or more virtual environments. In the illustrative example, information associated with user account 120 in virtual environment user database 118 includes purchase history 122, demographic data 124, billing data 126, virtual assets 128 and user game data 130.

Purchase history 122 may include information such as purchases of virtual goods, purchases of virtual currency, purchases of access to a virtual environment, the date of a purchase, and the amount paid for the purchase by the user. Demographic data 124 may include information such as the gender, age, race, and location (e.g, country, state, city, etc.) of the user. Billing data 126 may include information used to obtain payment from the user, such as a payment account identifier, billing address, and other contact information such as a phone number and e-mail address for the user. Virtual assets 128 may store information about the user's holdings in a virtual environment in association with user account 120. For example, virtual goods 132 held by the user are stored in association with user account 120. Virtual assets 128 may also include information about the amount of virtual currency 134 usable in the virtual environment held by the user. In some embodiments, multiple types of virtual currency may be held by the user.

Additional information that may be stored in association with user account 120 includes information about the user's status within the virtual environment. For example, the user may have selected a character type for use within the virtual environment. Character type 138 may also or alternatively indicate the gender or other characteristics of the character. The character may be an avatar that is visible in the virtual environment. For a virtual environment that is a game, the user may have attained a skill level within the game. User game data 130 may store virtual environment user data such as character user character type 138 and user skill level 136 in association with a user account 120.

In some embodiments, a virtual environment is associated with a social network or other application having access to user data. Virtual environment server computer 108 may obtain one or more user attributes from a database associated with the social network.

Virtual environment server computer 108 is further communicatively coupled to a virtual goods database 140. In some embodiments, a single database includes both virtual goods database 140 and virtual environment user database 118. Virtual goods database 140 may store information about virtual goods, including virtual goods available for use in one or more virtual environments. A virtual good can be any non-physical item that may be stored in a computer readable medium, such as a hard drive or computer memory. Virtual goods include items that can be acquired for use in a virtual environment, such as by trade or by game play, and digital media. Examples of virtual goods include virtual possessions, services, characters, character features (health, possessions, skins, etc.) modifiers to other goods (e.g., a good that modifies health, possessions, etc.), points, digital music files, video files, and image files. Virtual goods may be acquired by a user within a virtual environment. Virtual goods may also be acquired in a marketplace or other user interface that is external to a virtual environment. Virtual goods database 140 will typically store a unique identifier for each virtual good. Information about the virtual good, such as the cost of the item in real currency or virtual currency or both, a character type with which the virtual good is associated, a game play level with which the virtual good is associated, a location within the virtual environment with which the virtual good is associated, etc., may be stored in association with the unique identifier for the virtual good.

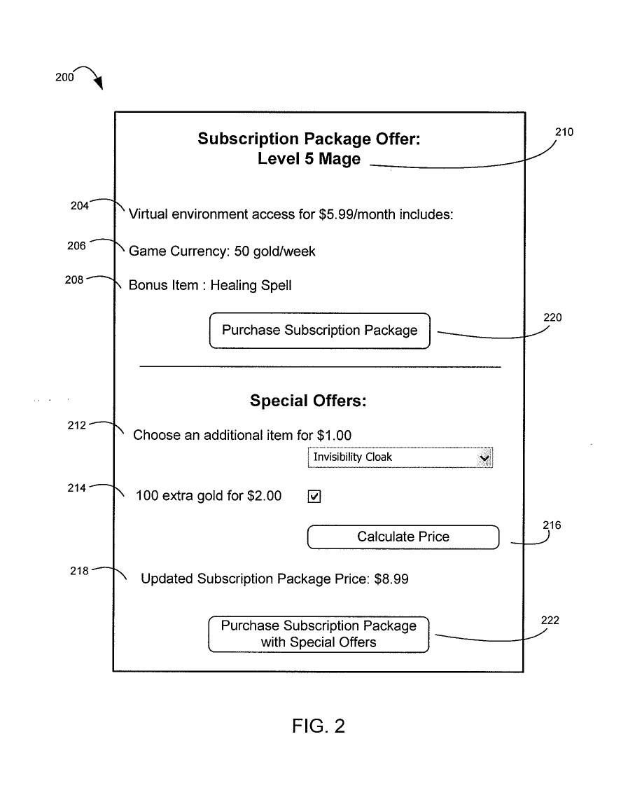

Referring now to FIG. 2, an illustrative customized subscription package offer is shown. Customized subscription package offer 200 is displayed by user interface application 104. The user interface application may be, for example, an application executed by a processor of client device 102 or an application run by a web browser of client device 102. The customized subscription package offer may include one or more virtual assets, such as virtual goods and virtual currency. The virtual goods may be usable in one or more virtual environments. One or more types of virtual currency may be offered, and the virtual currencies may be usable in one or more environments. The customized subscription package offer may also include access to one or more virtual environments. Access may be offered for a fixed period of time, such as a day, week, month or year. The access may be periodically renewable at the offered price over a particular period of time.

The illustrative customized subscription package offer shown in FIG. 2 includes monthly access to the virtual environment, as shown at 204. The customized subscription package offer also includes 50 units of currency (50 gold pieces) per week of access, as shown at 206. A virtual good is also included in the offer, as shown at 208. In some embodiments, the user may select a virtual good from a list of virtual goods options provided with the subscription package offer. The user may accept the offer, for example, by selecting a “Purchase Subscription Package” button as shown at 220.

The customized subscription package offer may be customized for the user to whom the offer is presented, based on one or more factors such as the user's past purchase history, demographic information, frequency of access to the virtual environment, virtual assets held by the user, and game data related to the user's participation in an online game, any of which may be determined from information stored in virtual environment user database 118. For example, a user who has never previously purchased a virtual good may receive a subscription package offer including a virtual good, such as the bonus item shown at 208, to encourage the user to purchase virtual goods. The components of the subscription package offer, such as virtual goods, virtual currency, and access options, may be customized based on the progress of users in the game. For example, the type, value or quantity of virtual goods offered to a user may be increased as a user progresses in the game, or the price of the subscription package may be decreased as a user progresses in the game. A user may be presented with a subscription package offer that will change over time. For example, the subscription package offer price may decrease each month that the user remains active within the virtual environment. The components of the subscription package may be based on other indicators of the user's interaction with the virtual environment, such as a particular location within the virtual environment being explored by a user or other context information related to the virtual environment, the length of time the user has spent using the virtual environment, the types of virtual environments determined to be appealing to the user, or a user's character type or gaming group within the virtual environment.

The virtual good may be particular to aspects of a user's participation in a virtual environment, such as a character selected for use by the user in an online game. If a virtual good, such as a magic item, may only be used by a certain character type, such as all character types enabled to use magic, a magic item may be presented to the user if the user has a character type enabled to use magic. In the illustrative example of FIG. 2, the character type is a mage, as shown at 210. If the virtual environment is an online game that allows users to achieve levels of game play, some virtual goods may be presented only to those users who have achieved a particular level. In the illustrative example of FIG. 2, the user level is level 5, as shown at 210. In an example of demographic customization, if certain items are determined to appeal to users within a particular age group, based on data collected about purchases made by users or as determined by a designer of the virtual environment, the item may be presented to users of the appropriate age group. In a further example of customization, if a user has not accessed or subscribed to the virtual environment for a particular period of time, the subscription offer may be presented to the user at a reduced price to provide the user with an incentive to accept the subscription package offer. In some embodiments, the customization of the subscription package offer is based on the purchase history of users having one or more of past purchases, demographic data, frequency of access, virtual assets or game data that are similar to those of the user.

In some embodiments, a user may alter one or more components of the customized subscription package offer, add one or more components to the customized subscription package offer, subtract one or more components from the customized subscription offer or design a new customized subscription package. In the illustrative example of FIG. 2, the customized subscription package offer includes the opportunity for the user to add a virtual item to the customized subscription package offer, as indicated at 212. The user is also presented with the opportunity to add virtual currency to the customized subscription package offer, as indicated at 214. After the user makes changes to a customized subscription package offer or designs a new subscription package, the price of the customized subscription offer is typically updated. The user may obtain an updated price for the changes made by, for example, selecting a “Calculate Price” button 216 of the user interface. The updated price may be displayed to the user, as indicated at 218. The user may accept the modified subscription package offer, for example, by selecting a “Purchase Subscription Package with Special Offers” button 222.

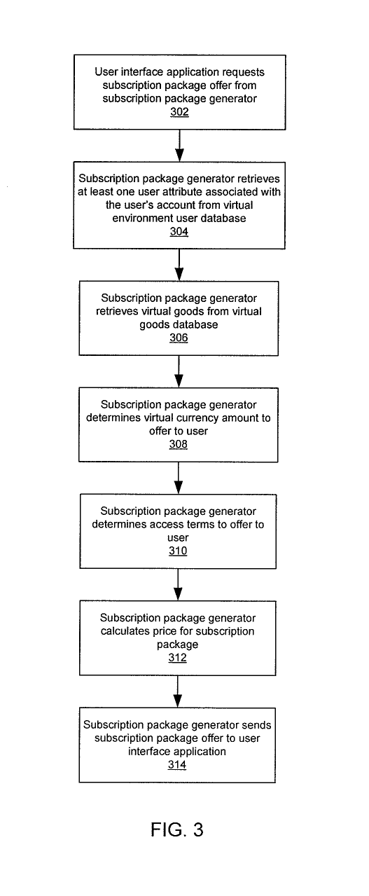

Referring to FIG. 3, a flow diagram shows illustrative operations involved in generating a subscription package offer. At operation 302, user interface application 104 sends a request to subscription package generator 114. The request may be sent when a user expresses an interest in receiving a subscription package offer, for example, by visiting a website or online marketplace associated with a virtual environment. At operation 304, the subscription package generator 114 queries virtual environment user database 118 to retrieve at least one user attribute associated with user account 120.

The subscription package generator may further retrieve one or more virtual goods from virtual goods database 140, as indicated at operation 306. The virtual goods retrieved by the subscription package generator may be associated with one or more user attributes of the user for whom the subscription package is being generated. For example, if user game data 130 indicates that the user's virtual goods 132 include a weapon and an upgrade to the weapon is available in the virtual goods database, the subscription package generator 114 may retrieve the upgrade to the weapon from virtual goods database 140.

In some embodiments, the subscription generator determines an amount of virtual currency to offer to the user, as indicated at operation 308. For example, if the purchase history 122 of the user indicates that the user has never purchased virtual currency, a predetermined amount of virtual currency may be included in the subscription package offer. In another example, if optimization engine 116 has determined that users that have reached a particular game level are more likely to accept subscription package offers including virtual currency than subscription package offers lacking virtual currency, subscription package generator 114 may determine based on user level 136 whether the user has reached the particular game level, and if so, virtual currency is included in the subscription package offer.

The subscription package may also include access to one or more virtual environments. The subscription package generator 114 may determine access terms to offer to a user as shown at operation 310. Access terms may include an access price, an access duration, and an option to renew the access at the access price for a predetermined number of periods of the duration. For example, a month of access to one or more virtual environments may be offered to the user for a predetermined price, and may be renewable at the offered price every month for a year. The access terms may be determined on the basis of one or more user attributes.

At operation 312, the subscription package generator calculates the price for the subscription package generated at operations 306-310. The subscription package price may be determined based on factors such as the price associated with each virtual good in the subscription package, the conversion rate between real currency and the virtual currency in the package, the access price, or a predetermined price for a particular subscription package or class of subscription packages.

At operation 314, the subscription package generator 114 sends a subscription package offer to user interface application 104. The subscription package offer is displayed to the user, who may accept, modify, or decline the offer.

In some embodiments, if the user declines the offer, an alternative offer is presented to the user. For example, the subscription package generator may adjust the value or quantity of virtual goods offered in the subscription package; adjust the amount of virtual currency offered; adjust the rate, duration or pricing of the access terms; adjust the price of the subscription package; or a combination of these.

After a first subscription package offer is presented to a user, a second subscription package offer presented to the user may be a variation on the first subscription package offer. A second subscription package offer may comprise one or more virtual assets in addition to the virtual assets of the first subscription package offer. In an illustrative example, a user has accepted a first subscription package offer, and when the access term of the first subscription package offer has expired, is subsequently presented with a second subscription package offer that has the same components as the first subscription package offer and an additional virtual asset. The second subscription package offer may have a price that is higher than the price of the first subscription package offer. In this manner, the user is provided with an incentive to spend more to obtain the additional item. In another example, a user who has declined a first subscription package offer is subsequently presented with a second subscription package offer that has the same components as the first subscription package offer and an additional virtual asset.

Alternatively, a user may be prompted by a user interface 104 to select a price for a subscription package. The components of the subscription package may be generated based on the selected price. For example, the amount of virtual currency included in the subscription package may be proportional, e.g., linearly related, to the selected price. Similarly, the value of virtual goods or price of the term of access may be proportional to the selected price.

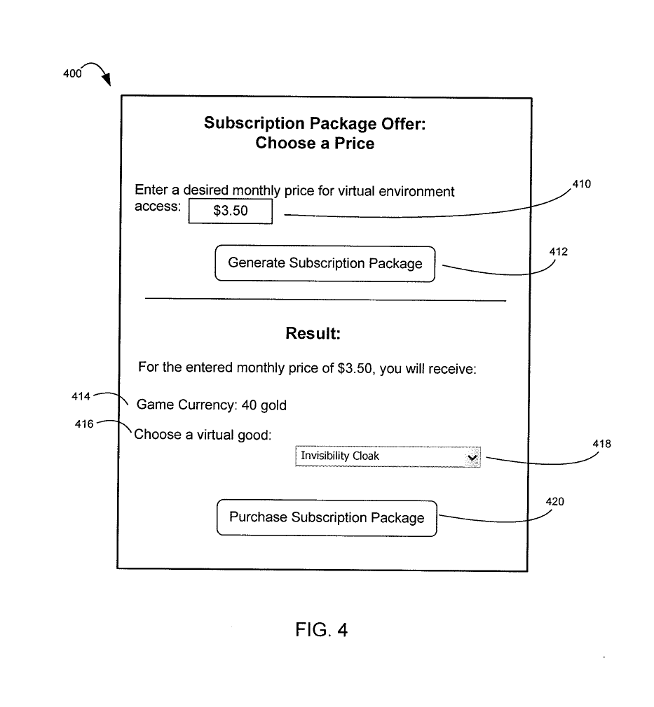

Referring to FIG. 4, an illustrative user interface for receiving a user input price and generating a customized subscription package offer based on the received price is shown. In the illustrative example shown in FIG. 4, a user is prompted to enter a price in text input box 410. It will be realized that alternative price selection means may be provided, such as a drop down box. The user has inputs a price of $3.50, as indicated at 410. The user may then select a “Generate Subscription Package” button 412 to generate a subscription package offer based on the price entered by the user. The selection of the “Generate Subscription Package” button 412 results in a request sent to subscription package generate 114 to generate a subscription package offer based on the price entered by the user. The subscription package generator determines one or more virtual assets that will be included in the subscription package offer. In the illustrative example of FIG. 4, the user is offered virtual currency of 40 gold, as indicated at 414. The amount of virtual currency may be determined based on the price entered by the user. For example, the amount of virtual currency may be proportional, e.g., linearly related, to the price entered by the user. In the illustrative example, the user is also offered and the choice of one virtual good, as indicated at 416. The illustrative drop down box shown at 418 may be populated with one or more virtual goods having a value that is determined based on the entered price. The value and/or quantity of virtual goods offered may be proportional to, e.g. linearly related to the entered price. The cost of access may also be determined based on the price entered by the user, and may be proportional to the price entered by the user. The user may accept the offer by selecting the “Purchase Subscription Package” button 420.

The subscription package generator 114 calculates the allotments for one or more of access, virtual currency, and virtual goods based on the user input price. The subscription package generator 114 then determines the amount of virtual currency that corresponds to the allotment of the price for virtual currency and determines one or more virtual goods to offer based on the allotment of the price for virtual goods. One or more of the virtual goods, virtual currency and access term in the subscription package may be determined based on user attributes of the user. The subscription package is offered to the user.

In an illustrative example of subscription package generation based on a user input price, the subscription package includes an access term having a fixed cost which is subtracted from the user input price. In the example, the remainder of the user input price is applied to virtual assets, with 20% of the remainder being allotted to virtual currency and 80% being allotted to virtual goods. Accordingly, if the user input price is $3.50 and the cost of the access term is $2.50, $0.20 of the remainder is allotted to virtual currency, and $0.80 is allotted to one or more virtual goods.

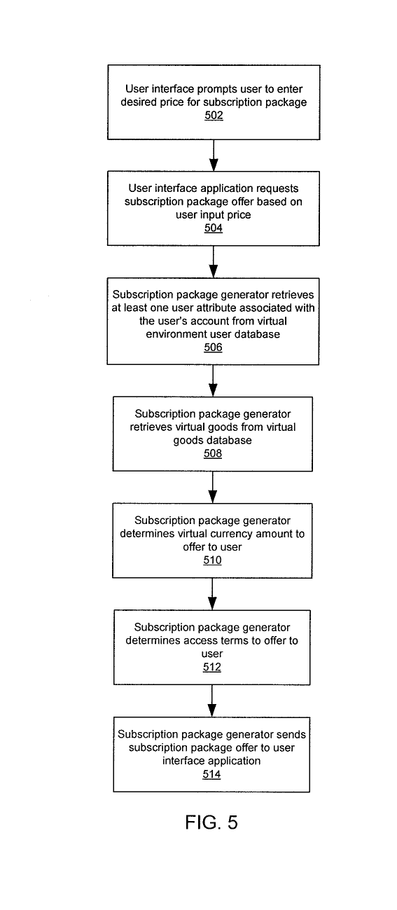

Referring now to FIG. 5, a flow diagram shows illustrative operations involved in generating a subscription package offer based on a user input price. At operation 502, user interface application 104 prompts a user to enter a desired subscription package price. At operation 504, user interface application 104 sends a request to subscription package generator 114 for a subscription package offer determined based on the user input price. At operation 506, the subscription package generator 114 may query virtual environment user database 118 to retrieve at least one user attribute associated with user account 120.

The subscription package generator may further retrieve one or more virtual goods from virtual goods database 140, as indicated at operation 508. The value of the virtual goods retrieved by the subscription package generator may be determined based on the user input price. For example, the value of the virtual goods may be proportional to the user input price.

The subscription generator may determine an amount of virtual currency to offer to the user, as indicated at operation 510. The value of the virtual currency offered to the user may be based on the user input price.

The subscription package may also include access to one or more virtual environments. The subscription package generator 114 may determine access terms to offer to a user as shown at operation 512. The access terms may be determined based on the user input price.

At operation 514, the subscription package generator 114 sends a subscription package offer to user interface application 104. The subscription package offer is displayed to the user, who may accept, modify, or decline the offer. In some embodiments, if the user declines the offer, an alternative offer is presented to the user.

Subscription Package Optimization

Subscription package acceptance rates and patterns may be monitored to improve targeting of subscription packages to each user. Aspects of the subscription package such as pricing and components of the package may be modified to improve the likelihood of acceptance of the subscription package by a particular user. In some embodiments, subscription packages may be trialed with subsets of users for optimization purposes. Optimization engine 116 may monitor all or a sampling of user responses to subscription package offers, analyze the data acquired by monitoring the responses, and alter subscription package offers based on the analysis of the data. FIGS. 4-6 indicate illustrative optimization techniques applied by optimization engine 116.

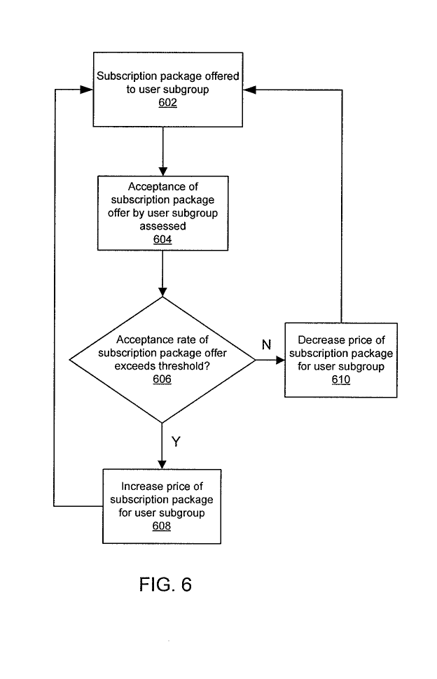

In a first illustrative example, the price of a particular subscription package may be optimized for a particular subgroup. Referring to FIG. 6, a flow diagram shows illustrative operations involved in optimizing the price of a subscription package. At operation 602, a subscription package is offered to a subgroup of users. The user subgroup may be composed of some or all users having a particular user attribute or set of user attributes in common. For example, the user subgroup may be all users who have purchased virtual goods previously, as indicated by purchase history 122 associated with user accounts 120 in virtual environment user database 118. In another example, the user subgroup may be a trial group of some of the users that have both purchased virtual goods previously and whose demographic data 124 indicate that the users are located in a particular region.

The acceptance of the subscription package offer by the user subgroup is assessed, as indicated at operation 604. For example, an acceptance rate may be calculated based on a number of accepted offers of a particular subscription package by a user subgroup over a particular period of time compared to a number of offers of the subscription package made to the user subgroup over the same period of time. The acceptance rate may be compared to a threshold rate, as indicated at operation 606. For example, the acceptance rate may be compared to a threshold rate of one offer accepted out of every three offers made of a particular subscription package to the user subgroup over a month long trial period. If the acceptance rate exceeds the threshold, the price of the subscription package may be increased for the user subgroup, as indicated at operation 608. If the acceptance rate does not exceed the threshold, the price of the subscription package may be decreased for the user subgroup, as indicated at operation 610. After the price of the subscription package is altered, the subscription package having the altered price is again offered to the user subgroup as indicated at operation 602. This feedback loop optimizes the pricing of a particular subscription package for a particular user subgroup. The optimization described with reference to FIG. 6 may be applied to optimize the pricing of a subscription package for the user base as a whole rather than for a subgroup of users. It will be realized that other optimization techniques may be used to optimize the price of a subscription package for a user base or a subgroup of users.

In alternative embodiments, the subscription package may be modified or discontinued for a particular user subgroup depending on the acceptance rate of the subscription package offer. For example, in each iteration of the loop illustrated in FIG. 6, instead of increasing the price of a subscription price as indicated at 608 or decreasing the price of the subscription package as indicated at 610, the amount of virtual currency in the subscription package could be increased or decreased, respectively. Alternatively, the optimization process could involve altering the number or value of virtual goods included in the subscription package.

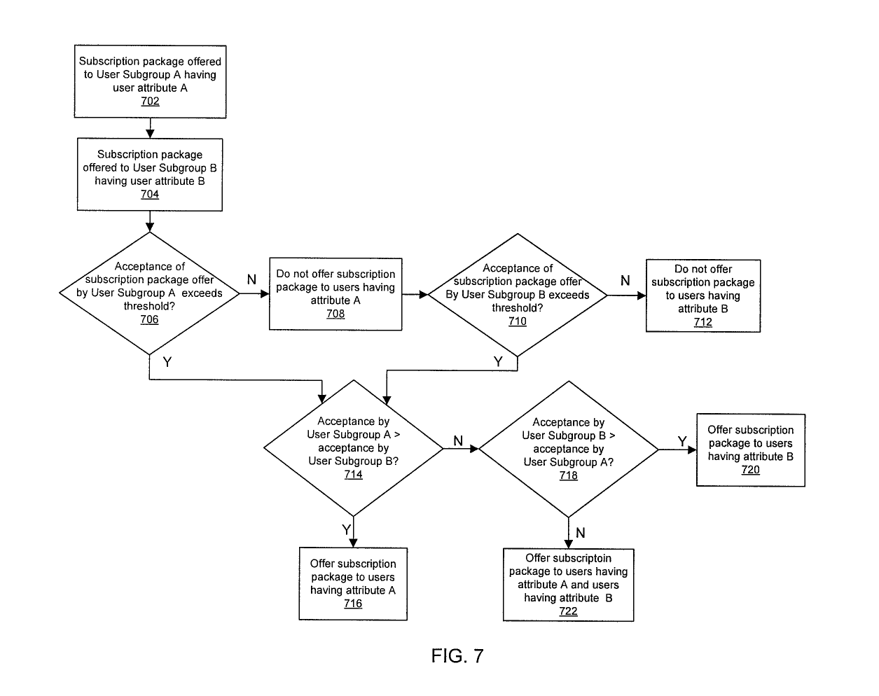

In some embodiments, a subscription package is presented to two different subgroups of users to determine the relative appeal of the subscription package to the subgroups. The acceptance rates of the subgroups may be used to determine pricing for a subscription package, to determine components for inclusion in a subscription package, or to determine whether the subscription package will continue to be offered to users having an attribute of one or both of the subgroups. Referring now to FIG. 7, a flow diagram shows illustrative operations involved in customizing subscription package offerings for user subgroups. A subscription package is offered to User Subgroup A having user attribute A at operation 702. The subscription package is also offered to User Subgroup B having user attribute B, as indicated at operation 704. For example, a subscription package may be tested in a first user subgroup having a first age range and a second user subgroup having a second age range to determine if the subscription package performs better with users within a particular age group.

At operation 706, the acceptance rate of the subscription package by User Subgroup A is analyzed to determine whether the acceptance rate by User Subgroup A exceeds a threshold acceptance rate. If the acceptance rate does not exceed the threshold, the subscription package may be discontinued for User Subgroup A, as indicated at operation 708. At operation 710, the acceptance rate of the subscription package by User Subgroup B is analyzed to determine whether the acceptance rate by User Subgroup B exceeds a threshold acceptance rate. If the acceptance rate does not exceed the threshold, the subscription package may be discontinued for User Subgroup B, as indicated at operation 712.

If the acceptance rate for either User Subgroup A or User Subgroup B exceeds a threshold rate, it may be determined whether the acceptance rate for User Subgroup A exceeds the acceptance rate for User Subgroup B, as indicated at operation 714. If the acceptance rate for User Subgroup A exceeds the acceptance rate for User Subgroup B, the subscription package is offered to users having attribute A, as indicated at operation 716. For example, if users in the age group 13-16 are more likely to accept a particular subscription package than users in the age group 17-20, the subscription package may be presented only to the users in the age group 13-16. If the acceptance rate for User Subgroup A does not exceed the acceptance rate for User Subgroup B, it is determined whether the acceptance rate for User Subgroup B exceeds the acceptance rate for User Subgroup A, as indicated at operation 718. If the acceptance rate for User Subgroup B exceeds the acceptance rate for User Subgroup A, the subscription package is offered to users having attribute B, as indicated at operation 720. If the acceptance rate for User Subgroup B does not exceed the acceptance rate for User Subgroup A, the subscription package is offered to users having attribute A and users having attribute B, as indicated at operation 722. Accordingly, if both subgroups have demonstrated an interest in the subscription package, the subscription package is offered to both subgroups.

Different subscription packages may be presented to the user base or a sampling of the user base to determine the relative appeal of the different subscription packages. The comparison of acceptance rates of the different subscription packages can be used to determine pricing of a subscription package, to determine components of a subscription package, or to determine whether the whether the subscription package will continue to be offered to users. Referring to FIG. 6, a flow diagram shows illustrative operations involved in comparing acceptance rates of first and second subscription package offerings. FIG. 7 shows exemplary first and second subscription package offerings.

At operation 602, subscription package A, such as the monthly subscription package offering shown in FIG. 7A, is offered to user sample A. User sample A may be a random sampling of the user base. In another embodiment, the user sample may be a subgroup of the user base having one or more common user attributes. At operation 604, subscription package B, such as the weekly subscription package offering shown in FIG. 7B, is offered to user sample B. At operation 606, it is determined whether the acceptance rate of subscription package offer A exceeds the acceptance rate of subscription package offer B. If so, subscription package A is offered to the user base, as indicated at operation 608. Accordingly, in the illustrative example, if a sampling of users are shown to be more likely to accept monthly subscription offers, monthly subscription offers are presented to the user base. If the acceptance rate of subscription package offer A does not exceed the acceptance rate of subscription package offer B, it is determined whether the acceptance rate of subscription package offer B exceeds the acceptance rate of subscription package offer A, as indicated at operation 610. If so, subscription package B is offered to the user base. Accordingly, in the illustrative example, if a sampling of users are shown to be more likely to accept weekly subscription offers, weekly subscription offers are presented to the user base. If the acceptance rate of subscription package offer B does not exceed the acceptance rate of subscription package offer A, both subscription packages are offered to the user base, as indicated at operation 614. Accordingly, in the illustrative example, if a sampling of users are shown to be equally likely to accept weekly and monthly subscription offers, both weekly and monthly subscription offers are presented to the user base.

In some embodiments, access rates, virtual currency amounts, or the number or value of virtual goods in the subscription packages may be modified based on relative acceptance rates of the first subscription offer and the second subscription offer.

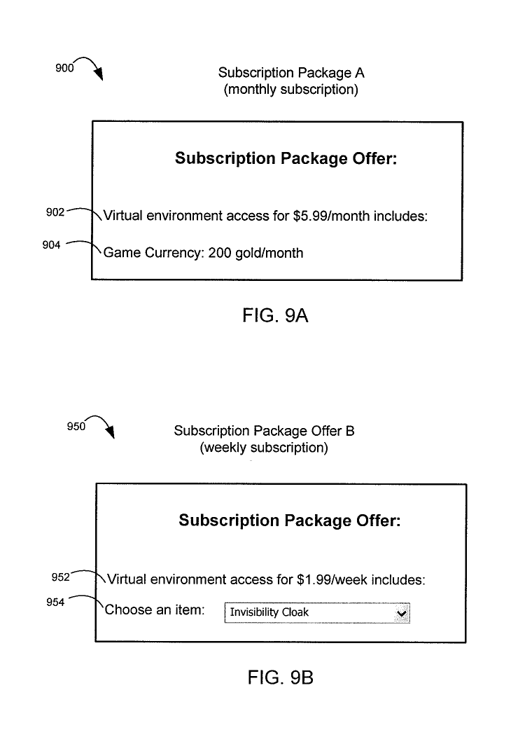

Referring now to FIGS. 9A-9B, exemplary subscription package offers are shown. In FIG. 9A, monthly subscription offer 900 comprises access component 902 and virtual currency component 904. In FIG. 9B, weekly subscription offer 950 comprises access component 952 and virtual good component 954.

System Devices

The various participants and elements described herein with reference to FIG. 1 may operate one or more computer apparatuses to facilitate the functions described herein. Any of the elements in FIG. 1, including any servers or databases, may use any suitable number of subsystems to facilitate the functions described herein.

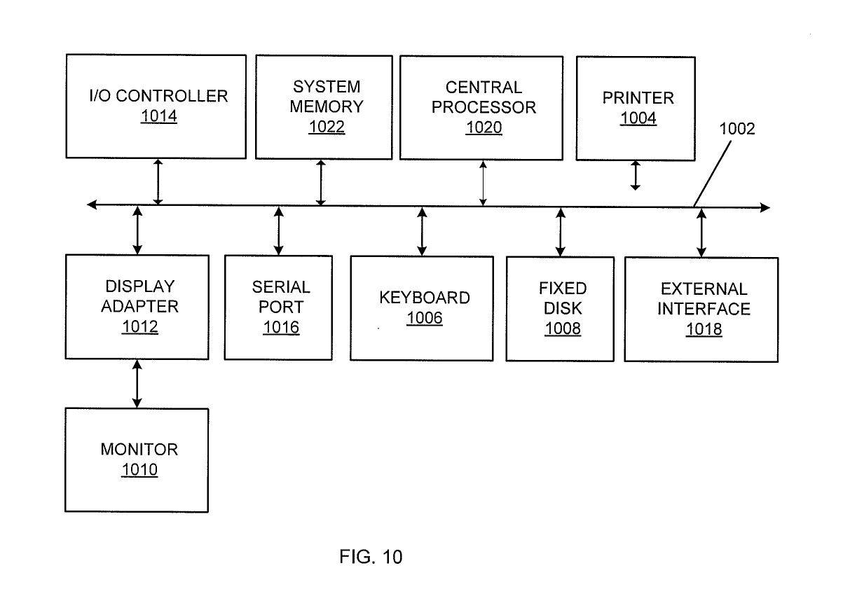

Examples of such subsystems or components are shown in FIG. 10. The subsystems shown in FIG. 10 are interconnected via a system bus 1002. Additional subsystems such as a printer 1004, keyboard 1006, fixed disk 1008 (or other memory comprising computer readable media), monitor 1010, which is coupled to display adapter 1012, and others are shown. Peripherals and input/output (I/O) devices, which couple to I/O controller 1014 (which can be a processor or other suitable controller), can be connected to the computer system by any number of means known in the art, such as serial port 1016. For example, serial port 1016 or external interface 1018 can be used to connect the computer apparatus to a wide area network such as the Internet, a mouse input device, or a scanner. The interconnection via system bus allows the central processor 1020 to communicate with each subsystem and to control the execution of instructions from system memory 1022 or the fixed disk 1008, as well as the exchange of information between subsystems. The system memory 1022 and/or the fixed disk 1008 may embody a computer readable medium.

Embodiments of the invention are not limited to the above-described embodiments. For example, although separate functional blocks are shown for an issuer, payment processing network, and acquirer, some entities perform all of these functions and may be included in embodiments of invention.

Specific details regarding some of the above-described aspects are provided above. The specific details of the specific aspects may be combined in any suitable manner without departing from the spirit and scope of embodiments of the invention. For example, back end processing, data analysis, data collection, and other transactions may all be combined in some embodiments of the invention. However, other embodiments of the invention may be directed to specific embodiments relating to each individual aspect, or specific combinations of these individual aspects.

It should be understood that the present invention as described above can be implemented in the form of control logic using computer software (stored in a tangible physical medium) in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
analyzing, by a computer apparatus, one or more user attributes of a user of one or more virtual environments;
determining, by the computer apparatus, a customized subscription package for the user, wherein the customized subscription package comprises one or more virtual assets associated with the one or more virtual environments; and
offering the customized subscription package to the user.

2. The method of claim 1, wherein the customized subscription package further comprises a term of access to the one or more virtual environments.

3. The method of claim 1, wherein if the customized subscription package is not accepted, an alternative customized subscription package is offered to the user.

4. The method of claim 3, wherein offering the alternative customized subscription package comprises altering the value of one or more virtual assets in the customized subscription package is adjusted.

5. The method of claim 3, wherein offering the alternative customized subscription package comprises altering the quantity of virtual assets in the customized subscription package.

6. The method of claim 3, wherein offering the alternative customized subscription package comprises altering a price of the customized subscription package.

7. The method of claim 3, further comprising, when the customized subscription package is not accepted, iteratively modifying the customized subscription package and offering a modified subscription package to the user.

8. The method of claim 1, wherein if the user does not accept the customized subscription package, the customized subscription package is modifiable by a user interface application.

9. The method of claim 1, wherein at least one virtual asset is associated with a user attribute.

10. The method of claim 1, wherein at least one virtual asset is determined based on a user attribute.

11. A server computer comprising:
a processor; and
a computer readable medium coupled to the processor, the computer readable medium comprising code executable by a processor for implementing a method comprising:
analyzing, by a computer apparatus, one or more attributes of a user of one or more virtual environments;
determining, by the computer apparatus, a customized subscription package for the user, wherein the customized subscription package comprises one or more virtual assets associated with the one or more virtual environments; and
offering the customized subscription package to the user.

12. The method of claim 11, wherein the customized subscription package further comprises a term of access to the one or more virtual environments.

13. The method of claim 11, wherein if the customized subscription package is not accepted, an alternative customized subscription package is offered to the user.

14. The method of claim 13, wherein offering the alternative customized subscription package comprises altering the value of one or more virtual assets in the customized subscription package is adjusted.

15. The method of claim 13, wherein offering the alternative customized subscription package comprises altering the quantity of virtual assets in the customized subscription package.

16. The method of claim 13, wherein offering the alternative customized subscription package comprises altering a price of the customized subscription package.

17. The method of claim 3, further comprising, when the customized subscription package is not accepted, iteratively modifying the customized subscription package and offering a modified subscription package to the user.

18. The method of claim 11, wherein if the user does not accept the customized subscription package, the customized subscription package is modifiable by a user interface application.

19. The method of claim 11, wherein at least one virtual asset is associated with a user attribute.

20. The method of claim 11, wherein at least one virtual asset is determined based on a user attribute.

21. A method comprising:
determining, by a computer apparatus, a first customized subscription package, wherein the first customized subscription package comprises a plurality of virtual assets usable in one or more virtual environments;
determining, but the computer apparatus, a second customized subscription package, wherein the second customized subscription package comprises a plurality of virtual assets usable in one or more virtual environments;
offering the first customized subscription package to a first subset of users;
offering the second customized subscription package to a second subset of users;
comparing the acceptance rate of the first customized subscription package by the first subset of users to the acceptance rate of the second customized subscription package by the second subset of users.

22. The method of claim 21, wherein if the acceptance rate of the first customized subscription package by the first subset of users exceeds the acceptance rate of the second customized subscription package by the second subset of users, the first customized subscription package is offered to a user base of the one or more virtual environments.

23. The method of claim 21, wherein
the first subset of users have a first user attribute;
the second subset of users have a second user attribute;
if the acceptance rate of the first customized subscription package by the first subset of users exceeds the acceptance rate of the second customized subscription package by the second subset of users, the first customized subscription package is offered to all users in the user base having the first user attribute.

24. A method comprising:
accepting, by a computer apparatus, a user input price for a subscription package;
determining, by the computer apparatus, a customized subscription package comprising one or more virtual assets associated with one or more virtual environments, wherein the value of at least one of the one or more virtual assets is proportional to the user input price; and
offering the customized subscription package to a user of the one or more virtual environments.

25. The method of claim 24, wherein the one or more virtual assets comprise virtual currency, wherein the amount of virtual currency in the customized subscription package is proportional to the user input price.

26. The method of claim 24, wherein the one or more virtual assets comprise one or more virtual goods, wherein the value of the virtual goods in the customized subscription package is proportional to the user input price.

27. The method of claim 24, wherein the customized subscription package further comprises a term of access to the one or more virtual environments.

28. The method of claim 27, wherein the price associated with the term of access is proportional to the user input price.

29. The method of claim 24, wherein the one or more virtual assets are determined based on one or more user attributes of the user.

30. A method comprising:
offering a first subscription package to a user, the first customized subscription package offer comprising one or more virtual assets associated with one or more virtual environments;
subsequently offering a second subscription package to the user, the second subscription package comprising the one or more virtual assets of the first subscription package offer and one or more additional virtual assets.
